(19) United States
(12) Patent Application Publication
(10) Pub. No.: US 2016/0134785 A1
(43) Pub. Date: May 12, 2016

(54) VIDEO AND AUDIO PROCESSING BASED MULTIMEDIA SYNCHRONIZATION SYSTEM AND METHOD OF CREATING THE SAME

(71) Applicant: EchoStar Technologies L.L.C., Englewood, CO (US)

(72) Inventor: Gregory H. Greene, Littleton, CO (US)

(21) Appl. No.: 14/537,664

(22) Filed: Nov. 10, 2014

(51) Int. Cl. H04N 5/04; H04N 5/44; G06K 9/00

(52) U.S. Cl. CPC H04N 5/04; G06K 9/00335; G06K 9/00268; H04N 5/44

(57) ABSTRACT

Various embodiments facilitate multimedia synchronization based on video processing and audio processing. In one embodiment, a multimedia synchronization system is provided to synchronize video and audio content by performing video processing on the video content, audio processing on the audio content, and a synchronization process. The video processing and the audio processing generate recognized lip movement and recognized speech, respectively. The synchronization process determines a match between lip movement of the recognized lip movement and speech of the recognized speech, and synchronizes the video content and the audio content based on the match.

### TECHNICAL FIELD

This disclosure relates to a multimedia synchronization system and methods of creating the same.

### BACKGROUND

Multimedia is often transmitted to users as video and audio streams that are decoded upon delivery. Transmitting separate video and audio streams, however, may result in synchronization issues. For example, the audio may lag behind or be ahead of the video. This may occur for a variety of reasons, such as the video and audio streams being transmitted from two distinct locations, transmission delays, and the video and audio streams having different decode times.

To avoid synchronization issues, video and audio streams are often accompanied with metadata, such as time stamp information. For example, a transport stream will often contain a video stream, an audio stream, and time stamp information. However, many applications do not or are unable to include metadata with video and audio streams. For example, many applications use elementary streams, which do not contain time stamp information, to transmit video and audio.

Video and audio synchronization is particularly important when multimedia content contains people speaking. Unsynchronized video and audio cause lip sync errors that are easily recognized by users and results in a poor viewing experience.

### BRIEF SUMMARY

According to one embodiment, a multimedia synchronization system is provided to synchronize video content and audio content by performing video processing, audio processing, and a synchronization process.

The video processing is performed on the video content to generate recognized lip movement. The recognized lip movement may include starts of sentences, ends of sentences, whole words, and sounds that correspond to specific letters of the alphabet. The recognized lip movement is generated by performing face detection on the video content, speaker detection on a detected face, and lip recognition on a detected face that is speaking.

The audio processing is performed on the audio content to generate recognized speech. The recognized speech may include starts of sentences, ends of sentences, whole words, and sounds that correspond to specific letters of the alphabet. The recognized speech is generated by performing speech recognition on the audio content.

The synchronization process is performed to synchronize the video content and the audio content. The synchronization process determines a match between lip movement of the recognized lip movement and speech of the recognized speech, and synchronizes the video content and the audio content based on the match.

The multimedia synchronization system provides video and audio synchronization when lip sync errors are most likely to occur, without the use of metadata.

### BRIEF DESCRIPTION OF THE SEVERAL VIEWS OF THE DRAWINGS

FIG. 1 is an overview block diagram illustrating an example of data flow for a multimedia synchronization environment according to one embodiment as disclosed herein.

FIG. 2 is a view illustrating an example of an entertainment system of a multimedia synchronization environment according to one embodiment as disclosed herein.

FIG. 3 is a block diagram illustrating an example of a multimedia synchronization environment according to one embodiment as disclosed herein.

FIG. 4 is a schematic illustrating an example of a host of a multimedia synchronization environment according to one embodiment as disclosed herein.

FIG. 5 is a flow diagram illustrating an example of video processing for a multimedia synchronization environment according to one embodiment as disclosed herein.

FIG. 6 is a flow diagram illustrating an example of audio processing for a multimedia synchronization environment according to one embodiment as disclosed herein.

FIG. 7 is a flow diagram illustrating an example of a synchronization process for a multimedia synchronization environment according to one embodiment as disclosed herein.

### DETAILED DESCRIPTION

### A. Overview

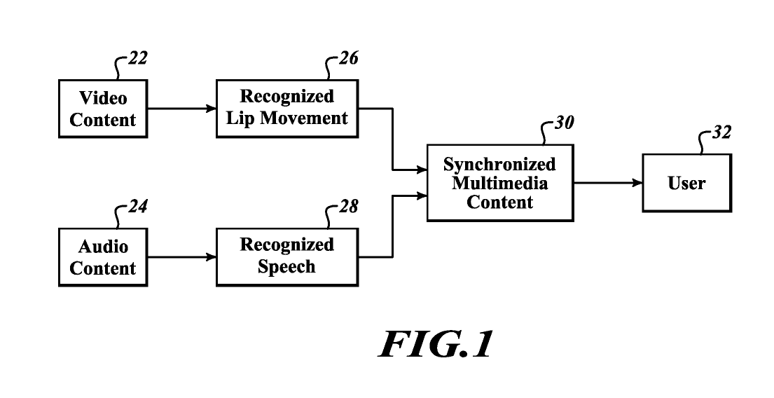

FIG. 1 is an overview block diagram illustrating an example of data flow for a multimedia synchronization environment according to principles disclosed herein. In this example, the multimedia synchronization environment includes video content 22, audio content 24, recognized lip movement 26, recognized speech 28, synchronized multimedia content 30, and a user 32.

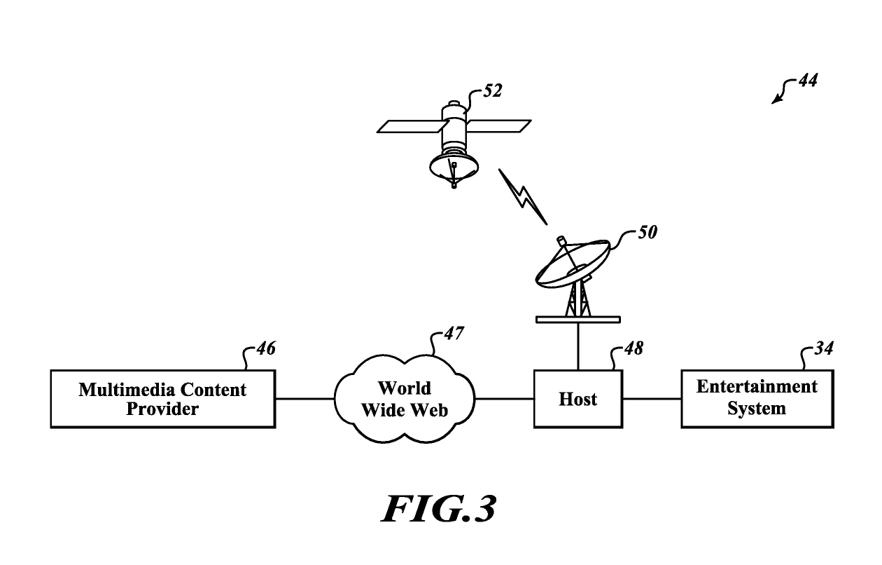

The video content 22 and the audio content 24 provide the video and sound, respectively, for multimedia content. For example, the video content 22 and the audio content 24 may provide the video and audio for television shows, movies, internet content, and video games. As will be discussed in detail with respect to FIG. 3, the video content 22 and the audio content 24 is provided by a multimedia content provider.

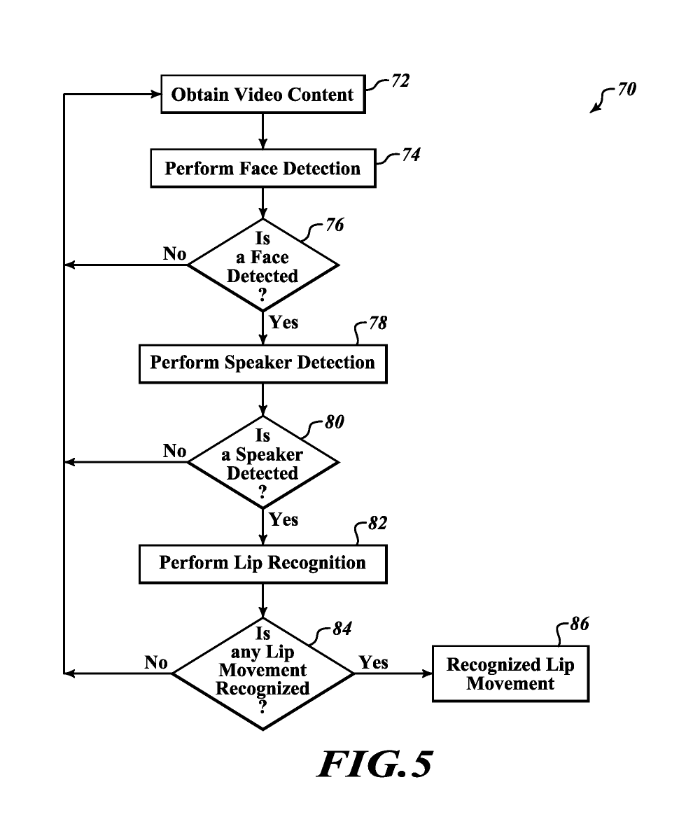

The recognized lip movement 26 is known lip movements that have been detected based on the video content 22. The recognized lip movement 26 may include starts of sentences, ends of sentences, whole words, and sounds that correspond to specific letters of the alphabet, such as “f,” “m,” “p,” “r,” “v,” and “w.” As will be discussed in detail with respect to FIG. 5, the recognized lip movement is be obtained by performing video processing on the video content 22.

The recognized speech 28 is known speech patterns that have been detected based on the audio content 24. The recognized speech 28 may include starts of sentences, ends of sentences, whole words, and sounds that correspond to specific letters of the alphabet, such as “f,” “m,” “p,” “r,” “v,” and “w.” As will be discussed in detail with respect to FIG. 6, the recognized speech 28 is be obtained by performing audio processing on the audio content 24.

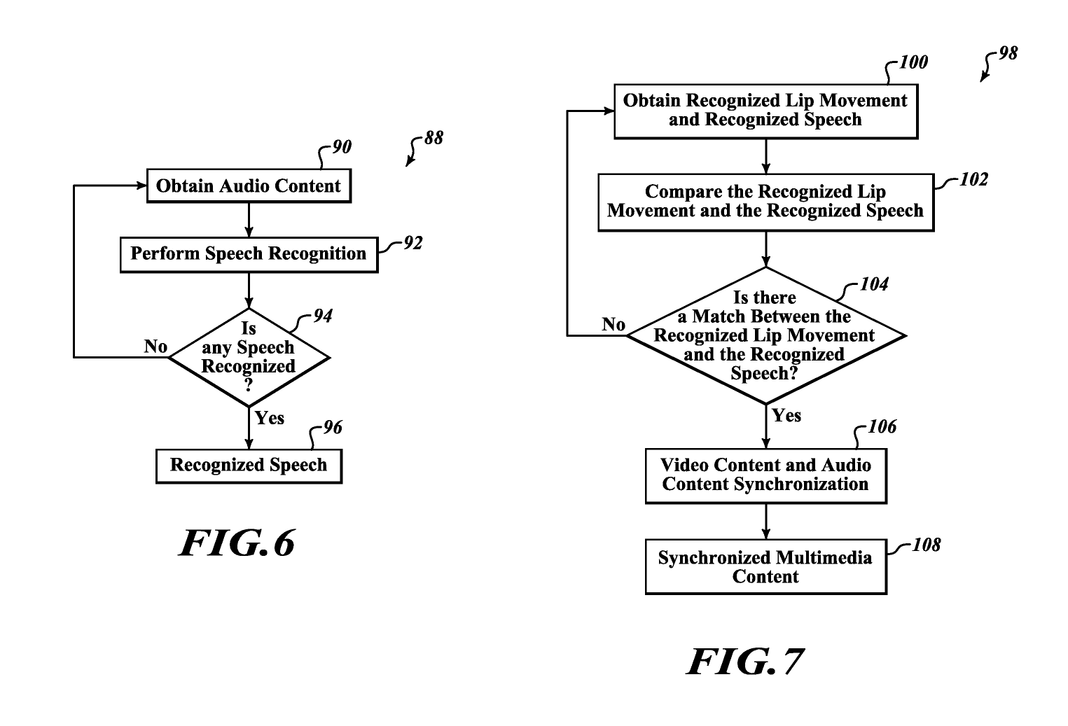

The synchronized multimedia content 30 is the video content 22 and the audio content 24 after they have been synchronized. The video content 22 and the audio content 24 are synched such that the audio does not lag behind or play ahead of the video. As will be discussed in detail with respect to FIG. 7, the synchronized multimedia content 30 is obtained by using the recognized lip movement 26 and the recognized speech 28 for a synchronization process.

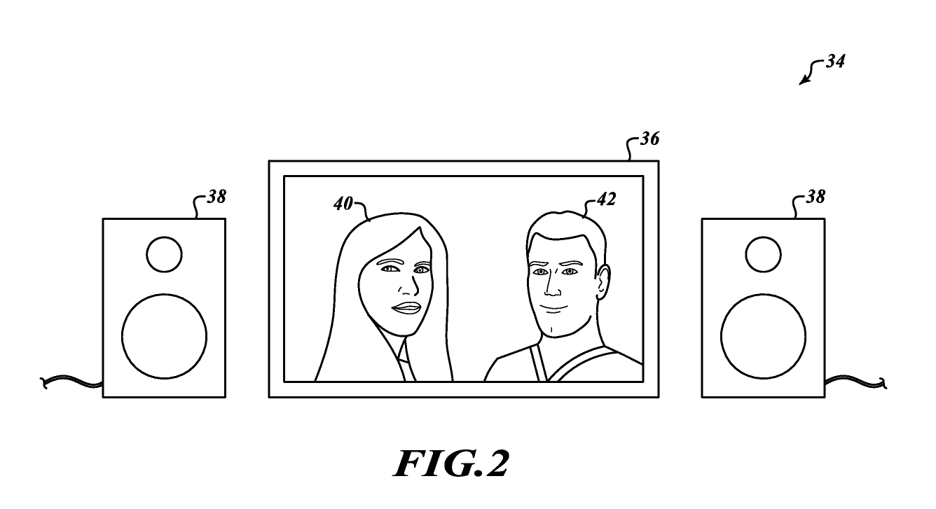

The user 32 is provided the synchronized multimedia content 30. Particularly, the user 32 is provided the video content 22 and the audio content 24 in sync with each other. As will be discussed in detail with respect to FIGS. 2 and 3, the synchronized multimedia content 30 is provided to the user 32 through an entertainment system. It should be noted that, although only the user 32 is shown in FIG. 1, the multimedia synchronization environment may include any number of users.

### B. Example Multimedia Synchronization Environment

FIG. 2 is a view illustrating an example of an entertainment system 34 according to principles disclosed herein. The entertainment system 34 is configured to provide the synchronized multimedia content 30 to the user 32. In this example, the entertainment system 34 includes a display 36 and speakers 38.

The display 36 is configured to provide video of the synchronized multimedia content 30 to the user 32. For example, the display 36 may depict a first person 40 speaking and a second person 42 listening. As will be discussed in detail with respect to FIG. 3, the video of the synchronized multimedia content 30 is provided by a host.

The speakers 38 are configured to provide the audio of the synchronized multimedia content 30 to the user 32. The speakers 38 are in the vicinity of the display 36 such that the user 32 is able see video on the display 36 and hear audio from the speakers 38 simultaneously. As will be discussed in detail with respect to FIG. 3, the audio of the synchronized multimedia content 30 is provided by a host.

FIG. 3 is a block diagram illustrating an example of a multimedia synchronization environment 44 according to principles disclosed herein. In this example, the multimedia synchronization environment 44 includes a multimedia content provider 46, a host 48, a receiver antenna 50, a satellite 52, and the entertainment system 34.

The multimedia content provider 46 is coupled to the host 48. The multimedia content provider 46 is a vendor that provides multimedia content, including the video content 22 and the audio content 24. In one embodiment, the multimedia content provider 46 provides multimedia content to the host 48 through a world wide web 47, such as the Internet. In another embodiment, the multimedia content provider 46 provides multimedia content to the host 48 through the receiver antenna 50 and the satellite 52. It should be noted that, although only the multimedia content provider 46 is shown in FIG. 3, the multimedia synchronization environment 44 may include any number of multimedia content providers. For example, a first multimedia content provider may be coupled to the host 48 through the world wide web 47 and a second multimedia content provider may be coupled to the host 48 through the receiver antenna 50 and the satellite 52. In a further embodiment, the host 48 receives the video content 22 and the audio content 24 from two separate multimedia content providers. For example, a first multimedia content provider may provide the video content 22 through the world wide web 47 and a second multimedia content provider may provide the audio content 24 though the receiver antenna 50 and the satellite 52, or vice versa.

The host 48 is coupled the multimedia content provider 46, the receiver antenna 50, and the entertainment system 34. As previously stated, the host 48 is configured to obtain multimedia content from the multimedia content provider 46 through the world wide web 47 and the receiver antenna 50. The host 48 may obtain the multimedia content from the multimedia content provider 46 by the multimedia content provider 46 pushing multimedia content to the host 48, or by the host 48 pulling multimedia content from the multimedia content provider 46. In one embodiment, the multimedia content provider 46 streams the multimedia content to the host 48. For instance, the host 48 may constantly receive multimedia content from the multimedia content provider 46. In other embodiments, the host 48 obtains multimedia content periodically, upon notification of multimedia content being updated, or on-demand, and stores multimedia content for future use. As will be discussed in detail with respect to FIGS. 5-7, the host 48 is further configured to perform video processing, audio processing, and a synchronization process to obtain the synchronized multimedia content 30.

The entertainment system 34 is coupled to the host 48. The host 48 provides the synchronized multimedia content 30 to the entertainment system 34. In one embodiment, the host 48 streams the synchronized multimedia content 30 to the entertainment system 34. In another embodiment, the host 48 stores the synchronized multimedia content 30 and provides the synchronized multimedia content 30 at a later time. As discussed with respect to FIG. 2, the entertainment system 34 is configured to provide the synchronized multimedia content 30 to the user 32.

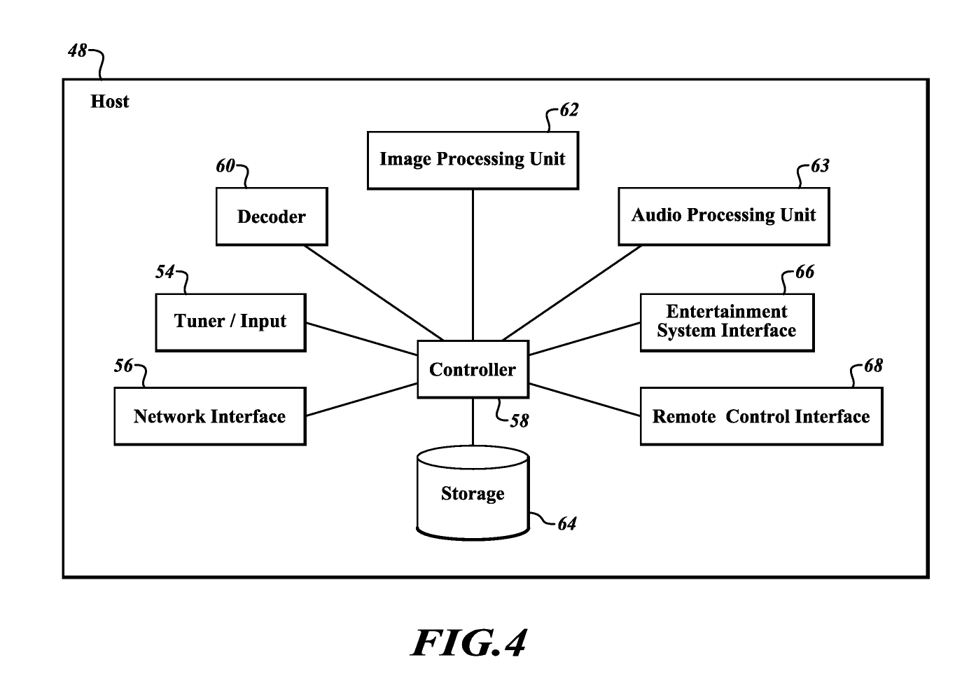

FIG. 4 is a schematic illustrating an example of the host 48 of the multimedia synchronization environment 44 according to principles disclosed herein. In this example, the host 48 includes a tuner/input 54, a network interface 56, a controller 58, a decoder 60, an image processing unit 62, an audio processing unit 63, storage 64, an entertainment system interface 66, and a remote control interface 68.

The tuner/input 54 is configured to receive data. For example, the tuner/input 54 may be coupled to the receiving antenna 50 to receive multimedia content from the multimedia content provider 46.

The network interface 56 is configured to connect to a world wide web to send or receive data. For example, the network interface 56 may be connected to the world wide web 47 to obtain multimedia content from the multimedia content provider 46.

The controller 58 is configured to manage the functions of the host 48. For example, the controller 58 may determine whether multimedia content has been received; determine whether multimedia content needs to obtained; coordinate video processing and audio processing; coordinate streaming and storage of multimedia content; and control the tuner/input 54, the network interface 56, the decoder 60, the image processing unit 62, the audio processing unit 63, the entertainment system interface 66, and the remote control interface 68. The controller 58 is further configured to perform synchronization processing. For example, as will be discussed in detail with respect to FIG. 7, the controller 58 may be configured to perform a synchronization process to obtain the synchronized multimedia content 30.

The decoder 60 is configured to decode multimedia content. For example, multimedia content may be encoded by the multimedia content provider 46 for transmission purposes and may need to be decoded for subsequent video and audio processing and playback.

The image processing unit 62 is configured to perform image and video processing. For example, as will be discussed in detail with respect to FIG. 5, the image processing unit 62 may be configured to perform video processing to obtain the recognized lip movement 26.

The audio processing unit 63 is configured to perform audio processing. For example, as will be discussed in detail with respect to FIG. 6, the audio processing unit 63 may be configured to perform audio processing to obtain the recognized speech 28.

The storage 64 is configured to store data. For example, the storage 64 may store the video content 22, the audio content 24, and the synchronized multimedia content 30. In one embodiment, the storage 64 is used to buffer multimedia content that is being streamed to the entertainment system 34. In another embodiment, the storage 64 stores multimedia content for future use.

The entertainment system interface 66 and the remote control interface 68 are configured to couple various electronic devices to the host 48. For instance, the entertainment system interface 66 may couple the entertainment system 34 to the host 48 and the remote control interface 68 may couple a remote control to the host 48.

It should be noted that each block shown in FIGS. 1-4 may represent one or more such blocks as appropriate to a specific embodiment or may be combined with other blocks.

It should also be noted that the host 48 may be any suitable electronic device that is operable to receive and transmit data. The host 48 may be interchangeably referred to as a “TV converter,” “receiving device,” “set-top box,” “TV receiving device,” “TV receiver,” “TV recording device,” “satellite set-top box,” “satellite receiver,” “cable set-top box,” “cable receiver,” “media player,” and “TV tuner.”

In another embodiment, the display 36 may be replaced by other presentation devices. Examples include a virtual headset, a monitor, or the like. Further, the host 48 and the entertainment system 34 may be integrated into a single device. Such a single device may have the above-described functionality of the host 48 and the entertainment system 34, or may even have additional functionality.

In another embodiment, the world wide web 47 may be replaced by other types of communication media, now known or later developed. Non-limiting media examples include telephony systems, cable systems, fiber optic systems, microwave systems, asynchronous transfer mode (“ATM”) systems, frame relay systems, digital subscriber line (“DSL”) systems, radio frequency (“RF”) systems, and satellite systems.

### C. Example Video Processing for a Multimedia Synchronization Environment

FIG. 5 is a flow diagram illustrating an example of video processing 70 for the multimedia synchronization environment 44 according to principles disclosed herein. The video processing 70 may be performed periodically, upon obtaining video content, prior to providing video content and audio content to a user, in real time, or on-demand.

At a first part of the sequence 72, video content is obtained. For example, the host 48 obtains the video content 22 from the multimedia content provider 46. In one embodiment, as previously discussed with respect to FIG. 3, the multimedia content provider 46 streams the video content 22 to the host 48. In another embodiment, the host 48 obtains the video content 22 from the storage 64. In a further embodiment, the obtained video content is a portion of the video content 22. The portion may be based on a number of frames, a video length, memory size, or any other factors.

In a subsequent step 74, face detection is performed on the obtained video content. For example, the host 48 performs face detection on the video content 22. The face detection may be performed by detecting patterns or geometric shapes that correspond to facial features, comparing detected patterns or geometric shapes with a database of known facial features, or using any other types of face detection, now known or later developed.

In step 76, it is determined whether a face has been detected by the face detection performed in step 74. For example, the host 48 determines whether any faces are present in the video content 22. If a face is detected in step 76, the video processing 70 moves to step 78. If a face is not detected in step 76, the video processing 70 returns to 72.

In step 78, speaker detection is performed on the face detected in step 76. For example, the host 48 performs speaker detection on a detected face in the video content 22. The speaker detection may detect speakers by detecting lip movements, detecting lip shapes, or using any other types of speaker detection, now known or later developed. If multiple faces were detected in step 76, speaker detection may be performed on a first detected face, a last detected face, a randomly selected detected face, a detected face based on predetermined factors, or all detected faces.

In step 80, it is determined whether a speaker has been detected by the speaker detection performed in step 78. For example, the host 48 determines whether any of the detected faces are speaking in the video content 22. If a speaker is detected in step 80, the video processing 70 moves to step 82. If a speaker is not detected in step 80, the video processing 70 returns to 72.

In step 82, lip recognition is performed on the detected speaker in step 80. For example, the host 48 performs lip recognition on a detected face that was detected speaking in the video content 22. As discussed with respect to FIG. 1, the recognized lip movement may correspond to starts of sentences, ends of sentences, whole words, and specific letters of the alphabet. The lip recognition may be performed by detecting unique patterns or lip shapes that correspond to particular words or letters, comparing detected patterns or lip shapes with a database of known patterns or lip shapes, or using any other types of lip recognition, now known or later developed. If multiple speakers were detected in step 80, lip recognition may be performed on a first detected speaker, a last detected speaker, a randomly selected speaker, a speaker based on predetermined factors, or all detected speakers. Various software programs from reading lips have been developed, such as by Intel or Hewlett Packard, which have commercial products on the market.

In step 84, it is determined whether any lip movement has been recognized by the lip recognition performed in step 82. For example, the host 48 determines whether any of the lip movements of the detected speakers are recognizable in the video content 22. If any lip movement is recognized in step 84, the video processing 70 moves to step 86. If no lip movement is recognized in step 84, the video processing 70 returns to step 72.

In step 86, recognized lip movement is generated. For example, the host 48 generates the recognized lip movement 26. As will be discussed in detail with respect to FIG. 7, the recognized lip movement is used for a synchronization process.

In an illustrating example of the video processing 70, in step 72, the multimedia content provider 46 streams the video content 22 to the host 48, either through the world wide web 47 or the receiver antenna 50. Upon obtaining the video content 22, the host 48 performs face detection on the video content 22 to detect faces in step 74. In step 76, faces of the first person 40 and the second person 42 are detected. In step 78, speaker detection is performed on the first person 40 and the second person 42. In step 80, the first person 40 is detected to be speaking. In step 82, lip recognition is performed on the first person 40 to recognize starts of sentence, ends of sentence, whole words, and specific letters of the alphabet. When lip movement is recognized in step 84, the recognized lip movement 26 is generated in step 86.

### D. Example Audio Processing for a Multimedia Synchronization Environment

FIG. 6 is a flow diagram illustrating an example of audio processing 88 for the multimedia synchronization environment 44 according to principles disclosed herein. The audio processing 88 may be performed periodically, upon obtaining audio content, prior to providing video content and audio content to a user, in real time, or on-demand. In one embodiment, the audio processing 88 is performed in parallel with the video processing 70.

At a first part of the sequence 90, audio content is obtained. For example, the host 48 obtains the audio content 24 from the multimedia content provider 46. As previously discussed with respect to FIG. 3, in one embodiment, the multimedia content provider 46 streams audio content to the host 48. In another embodiment, the host 48 obtains audio content from the storage 64. In a further embodiment, the obtained audio content is a portion of the audio content 24. The portion may be based on an audio length, memory size, or any other factors.

In a subsequent step 92, speech recognition is performed on the obtained audio content. For example, the host 48 performs speech recognition on the audio content 24. As discussed with respect to FIG. 1, the recognized speech may include starts of sentences, ends of sentences, whole words, and specific letters of the alphabet. The speech recognition may be performed by using statistical models, detecting speech patterns, or using any other types of speech recognition, now known or later developed.

In step 94, it is determined whether any speech has been recognized by speech recognition performed in step 92. For example, the host 48 determines whether any of the speech is recognizable in the audio content 24. If any speech is recognized in step 94, the audio processing 88 moves to step 96. If no speech is recognized in step 94, the audio processing 88 returns to step 90.

In step 96, recognized speech is generated. For example, the host 48 generates the recognized speech 28. As will be discussed in detail with respect to FIG. 7, the recognized speech is used for a synchronization process.

In an illustrating example of the audio processing 88, in step 90, the multimedia content provider 46 streams the audio content 24 to the host 48, either through the world wide web 47 or the receiver antenna 50. Upon obtaining the audio content 24, the host 48 performs speech recognition on the audio content 24 to recognize starts of sentences, ends of sentences, whole words, and specific letters of the alphabet in step 92. When speech is recognized in step 94, the recognized speech 28 is generated in step 96.

### E. Example Synchronization Process for a Multimedia Synchronization Environment

FIG. 7 is a flow diagram illustrating an example of a synchronization process 98 for the multimedia synchronization environment 44 according to principles disclosed herein. The synchronization process 98 may be performed periodically, upon obtaining recognized lip movement and recognized speech, prior to providing video content and audio content to a user, in real time, or on-demand.

At a first part of the sequence 100, recognized lip movement and recognized speech is obtained. For example, the host 48 obtains the recognized lip movement 26 and the recognized speech 28. In one embodiment, the host 48 obtains the recognized lip movement 26 and the recognized speech 28 by performing the video processing 70 and the audio processing 88, respectively. In another embodiment, the video processing 70 and the audio processing 88 is performed by a separate entity, such as the media content provider 46, and the recognized lip movement 26 and the recognized speech 28 is transmitted to the host 48.

In a subsequent step 102, the recognized lip movement and the recognized speech obtained in step 100 are compared. For example, the host 48 compares the recognized lip movement 26 to the recognized speech 28 to determine whether any recognized starts of sentences, ends of sentences, whole words, and specific letters of the recognized lip movement 26 matches any recognized starts of sentences, ends of sentences, whole words, and specific letters of the recognized speech 28. A match between the recognized lip movement 26 and the recognized speech 28 represent points in video content and audio content that should be synchronized. The comparison may be performed by using statistical methods, or using any other types of comparison methods, now known or later developed.

In step 104, it is determined whether there is a match between the recognized lip movement and the recognized speech based on the comparison performed in step 102. For example, the host 48 determines whether any lip movement of the recognized lip movement 26 matches with any speech of the recognized speech 28. If there is a match between the recognized lip movement and the recognized speech in step 104, the synchronization process 98 moves to step 106. If there are no matches between the recognized lip movement and the recognized speech in step 104, the synchronization process 98 returns to step 100.

In step 106, video content and audio content are synchronized based on the match determined in step 104. For example, the host 48 synchronizes the video content 22 and the audio content 24 based on a match between the recognized lip movement 26 and the recognized speech 28. The synchronization may be performed by speeding up video or audio content such that a determined match is synchronized, delaying video or audio content such that a determined match is synchronized, or using any other types of synchronization methods, now known or later developed. If multiple matches were determined in step 104, video content and audio content may be synchronized based on a first determined match, a last determined match, a randomly selected match, a match based on predetermined factors, or all determined matches.

In step 108, synchronized multimedia content is generated. For example, the host 48 generates the synchronized multimedia content 30. As discussed with respect to FIG. 1, the synchronized multimedia content 30 is then provided to the user 32.

In an illustrating example of the synchronization process 98, in step 100, the host 48 obtains the recognized lip movement 26 and the recognized speech 28 by performing the video processing 70 and the audio processing 88, respectively. Subsequently, in step 102, the host 48 compares the recognized lip movement 26 and the recognized speech 28. When a match between the recognized lip movement 26 and the recognized speech 28 is determined in step 104, the video content 22 and the video content 24 are synchronized based on the match in step 106. The synchronized multimedia content 30 is then generated in step 108.

In one embodiment, the synchronization process 98 synchronizes video content and audio content based on gender recognition, in addition to the recognized lip movement 26 and the recognized speech 28. In this embodiment, the video processing 70 further includes performing visual gender recognition on the video content 22 to determine whether a detected face in step 76 is male or female. The visual gender recognition may be performed by detecting patterns or geometric shapes that correspond to male or female features, comparing detected patterns or geometric shapes with a database of known male and female features, or using any other types of visual gender recognition, now known or later developed. The audio processing 88 further includes performing audio gender recognition on the audio content 24 to determine whether recognized speech in step 94 is male or female. The audio gender recognition may be performed by using statistical models, detecting speech patterns, or using any other types of audio gender recognition, now known or later developed. Subsequently, the synchronization process 98 synchronizes the video content 22 and the audio content 24 based on the visual gender recognition, the audio gender recognition, and the match determined in step 104. For example, the synchronization process 98 may determine whether the lip movement and speech of the match also correspond in gender, and, if so, synchronize the video content 22 and the audio content 24 such that the determined match is synchronized.

1. A method, comprising:
obtaining, by a host, video content and audio content;
performing, by the host, video processing on the video content, the video processing including:
detecting a presence of a face in the video content by performing face detection,
detecting the face speaking by performing speaker detection, and
recognizing lip movements of the face speaking by performing lip recognition;
performing, by the host, audio processing on the audio content, the audio processing including:
recognizing speech in the audio content by performing speech recognition;
performing, by the host, a synchronization process, the synchronization process including:
determining a match between a lip movement of the recognized lip movements and speech of the recognized speech, and
synchronizing the video content and the audio content based on the match; and
providing, by the host, the synchronized video content and audio content to a user.

2. The method according to claim 1, wherein the host is a set-top box.

3. The method according to claim 1, wherein the video processing and the audio processing are performed in parallel.

4. The method according to claim 1, wherein the synchronization process is performed periodically.

5. The method according to claim 1, wherein the recognized lip movements includes a lip movement that corresponds to a start of a sentence, the match being between the lip movement that corresponds to the start of the sentence and speech of the recognized speech that corresponds to the start of the sentence.

6. The method according to claim 1, wherein the recognized lip movements includes a lip movement that corresponds to a letter of an alphabet, the match being between the lip movement that corresponds to the letter of the alphabet and speech of the recognized speech that corresponds to the letter of the alphabet.

7. A method, comprising:
obtaining, by a host, a video stream and an audio stream;
providing, by the host, the video stream and the audio stream to a user;
performing, by the host, video processing on the video stream in real time, the video processing including:
detecting a presence of a face in the video stream by performing face detection,
detecting the face speaking by performing speaker detection, and
recognizing lip movements of the face speaking by performing lip recognition;
performing, by the host, audio processing on the audio stream in real time, the audio processing including:
recognizing speech in the audio stream by performing speech recognition;
performing, by the host, a synchronization process, the synchronization process including:
determining a match between a lip movement of the recognized lip movements and speech of the recognized speech, and
synchronizing the video stream and the audio stream based on the match; and
providing, by the host, the synchronized video stream and audio stream to a user.

8. The method according to claim 7, wherein the host is a set-top box.

9. The method according to claim 7, wherein the video processing and the audio processing are performed in parallel.

10. The method according to claim 7, wherein the synchronization process is performed periodically.

11. The method according to claim 7, wherein the recognized lip movements includes a lip movement that corresponds to a start of a sentence, the match being between the lip movement that corresponds to the start of the sentence and speech of the recognized speech that corresponds to the start of the sentence.

12. The method according to claim 7, wherein the recognized lip movements includes a lip movement that corresponds to a letter of an alphabet, the match being between the lip movement that corresponds to the letter of the alphabet and speech of the recognized speech that corresponds to the letter of the alphabet.

13. A method, comprising:
obtaining, by a host, video content and audio content;
performing, by the host, video processing on the video content, the video processing including recognizing lip movements of a face in the video content by performing lip recognition;
performing, by the host, audio processing on the audio content, the audio processing including recognizing speech in the audio content by performing speech recognition; and
performing, by the host, a synchronization process, the synchronization process including synchronizing the video content and the audio content based on the recognized lip movements and the recognized speech.

14. The method according to claim 13, wherein the video processing further includes detecting a presence of the face in the video content by performing face detection and detecting the face speaking by performing speaker detection, the lip recognition being performed in response to detecting the face speaking.

15. The method according to claim 13, wherein the synchronization process further includes determining a match between a lip movement of the recognized lip movements and speech of the recognized speech, the synchronizing of the video content and the audio content being based on the match.

16. The method according to claim 13, wherein the host is a set-top box.

17. The method according to claim 13, wherein the video processing and the audio processing are performed in parallel.

18. The method according to claim 13, wherein the synchronization process is performed periodically.

19. The method according to claim 13, wherein the recognized lip movements includes a lip movement that corresponds to a start of a sentence.

20. The method according to claim 13, wherein the recognized lip movements includes a lip movement that corresponds to a letter of an alphabet.
